(19) United States
(12) Patent Application Publication
(10) Pub. No.: US 2011/0004379 A1
(43) Pub. Date: Jan. 6, 2011

(54) INTERFERENCE PREVENTION CONTROL DEVICE OF WORK MACHINE

(75) Inventor: Isao Murota, Tokyo (JP)

Correspondence Address: MCDERMOTT WILL & EMERY LLP, 600 13TH STREET, N.W., WASHINGTON, DC, 20005-3096, US

(73) Assignee: Caterpillar Sarl, Geneva (CH)

(21) Appl. No.: 12/866,835

(22) PCT Filed: Jan. 22, 2009
(86) PCT No.: PCT/JP2009/050933

§ 371 Date: Aug. 9, 2010

(30) Foreign Application Priority Data
Feb. 20, 2008 (JP) 2008-038649

(51) Int. Cl. G06F 7/00

(52) U.S. Cl. 701/50

(57) ABSTRACT

The present invention provides an interference prevention control device of a work machine, wherein the interference prevention control device is capable of preventing interference between the cab and a tool of the work equipment regardless of whether either one of the cab or the work equipment is moved while the other is being operated, and thereby improving operation efficiency of the work machine. With regard to a work machine provided with a movable cab, a cab position sensor for detecting a cab position, as well as a boom angle sensor and an arm angle sensor for detecting a position of a tool at the distal end of the work equipment, are connected to a controller. Solenoid-operated directional control valves for limiting the movement of a boom cylinder and an arm cylinder for operating the work equipment are disposed in pressure passages of a pilot-operated control valve, and the solenoids of the solenoid-operated directional control valves are connected to the controller. The controller computes moving vectors based on the position of the cab detected by the cab position sensor and the moving speed of the cab determined by differentiation, predicts the cab position where the cab should be after a prescribed time, and controls the boom cylinder and the arm cylinder by means of the solenoid-operated directional control valves so as to prevent interference between the predicted cab position and the tool position.

### CROSS REFERENCE TO PRIOR APPLICATIONS

This application is a U.S. National Phase application under 35 U.S.C. §371 of International Application No. PCT/JP2009/050933, filed on Jan. 22, 2009 and claims benefit of priority to Japanese Patent Application No. 2008-038649, filed on Feb. 20, 2008. The International Application was published in Japanese on Aug. 27, 2009 as WO 2009/104449 A1 under PCT Article 21(2). All of these applications are herein incorporated by reference.

### TECHNICAL FIELD

The present invention relates to an interference prevention control device of a work machine provided with a cab and a work equipment mounted on the machine body in such a manner that the cab and the work equipment are capable of moving independently of each other.

### BACKGROUND ART

With regard to a work machine provided with a cab and a work equipment mounted on the machine body in such a manner that the cab and the work equipment are capable of moving independently of each other, conventional cab interference prevention control for preventing interference between the cab and the work equipment is typically performed by detecting the distance moved by the cab, and adjusting the interference prevention range based on the result of the detection of the actual distance moved by the cab in order to prevent interference between the cab and the work equipment (e. g. see Japanese Patent No. 3,310,783 (pp 4 and 5, and FIGS. 3 to 5).

### SUMMARY OF THE INVENTION

As the interference prevention control described above adjusts the interference prevention range after actually ascertaining the distance moved by the cab, it is difficult to perform interference prevention control of the work equipment while the cab is moving. In addition, moving the cab while the work equipment is in operation may result in interference with the work equipment.

In order to solve the above problems, an object of the invention is to provide an interference prevention control device of a work machine, wherein the interference prevention control device is capable of preventing interference between the cab and a tool of the work equipment regardless of whether either one of the cab or the work equipment is moved while the other is being operated, and thereby improving operation efficiency of the work machine.

The present invention relates to an interference prevention control device of a work machine provided with a cab and a work equipment mounted on the machine body in such a manner that the cab and the work equipment are capable of moving independently of each other, the interference prevention control device including a cab position sensor, a tool position sensor, a limiting means, and a controller. The cab position sensor serves to detect a position of the cab. The tool position sensor serves to detect a position of a tool attached to the work equipment. The limiting means serves to limit movement of an actuator that serves to operate the work equipment. A moving speed of the cab is computed by differentiating a cab position detected by the cab position sensor. The controller serves to determine a moving vector of the cab based on the cab position and the moving speed of the cab; based on the moving vector of the cab, predict the cab position where the cab should be after a prescribed time; and control the movement of the actuator of the work equipment by means of the limiting means so as to prevent interference between the predicted cab position and the position of the tool.

The present invention also relates to an interference prevention control device of a work machine provided with a cab and a work equipment mounted on the machine body in such a manner that the cab and the work equipment are capable of moving independently of each other, the interference prevention control device including a cab position sensor, a tool position sensor, a limiting means, and a controller. The cab position sensor serves to detect a position of the cab. The tool position sensor serves to detect a position of a tool attached to the work equipment. The limiting means serves to limit movement of an actuator that operates to move the cab. A moving speed of the tool is computed by differentiating a tool position detected by the tool position sensor. The controller serves to determine a moving vector of the tool based on the tool position and the moving speed of the tool; based on the moving vector of the tool, predict the tool position where the tool should be after a prescribed time; and control the movement of the actuator of the cab by means of the limiting means so as to prevent interference between the predicted tool position and the position of the cab.

According further to the present invention, the actuator that has had its movement limited by the limiting means of the interference prevention control device of the work machine according to the present invention is a hydraulic actuator that has had its movement controlled by a pilot-operated control valve, and the limiting means is a solenoid-operated directional control valve disposed in a pilot passage of the pilot-operated control valve.

According more to of the present invention, the controller of the interference prevention control device of the work machine of the present invention is adapted to output a signal commanding maximum operation to the solenoid-operated directional control valve in cases where the controller determines, based on the predicted positional relationship after a prescribed time, that movement of the tool or the cab by a given amount will cause no interference between the tool and the cab, and output a command signal corresponding to the positional relationship in cases where the controller predicts interference.

According to the present invention, the controller determines a moving vector of the cab based on a cab position detected by the cab position sensor as well as a moving speed of the cab computed by differentiating the detected cab position; based on the moving vector of the cab, predicts the cab position where the cab should be after a prescribed time; and controls the movement of the actuator of the work equipment by means of the limiting means so as to prevent interference between the predicted cab position and the position of the tool. Therefore, work efficiency can be improved, because interference between the tool of the work equipment and the cab can be prevented even if the work equipment is moved while the cab is moving.

According to the present invention, the controller determines a moving vector of the tool based on a tool position detected by the tool position sensor as well as a moving speed of the tool computed by differentiating the detected tool position; based on the moving vector of the tool, predicts the tool position where the tool should be after a prescribed time; and controls the movement of the actuator of the work equipment by means of the limiting means so as to prevent interference between the predicted tool position and the position of the cab. Therefore, work efficiency can be improved, because interference between the tool of the work equipment and the cab can be prevented even if the cab is moved during operation, in other words while the work equipment is moving.

According further to the present invention, the limiting means is a solenoid-operated directional control valve disposed in a pilot passage of a pilot-operated control valve that serves to control movement of a hydraulic actuator. Therefore, it is possible to control movement of the hydraulic actuator with a high degree of accuracy and thereby reliably prevent interference between the tool of the work equipment and the cab.

According more to the present invention, in cases where the controller determines, based on the predicted positional relationship after a prescribed time, that movement of the tool or the cab by a given amount will cause no interference between the tool and the cab, the controller outputs a signal commanding maximum operation to the solenoid-operated directional control valve, thereby ensuring high-speed operation with high work efficiency. In cases where the controller predicts interference, the controller outputs a command signal corresponding to the positional relationship to the solenoid-operated directional control valve, thereby reducing the operation speed as the tool and the cab approach each other, leading to shock-free, smooth stoppage.

### BRIEF DESCRIPTION OF THE DRAWINGS

FIG. 1 is a control circuit diagram showing an interference prevention control device of a work machine according to an embodiment of the present invention.

FIG. 2 is a side view of a work machine equipped with the interference prevention control device.

FIG. 3 is a flow chart showing the details of interference prevention control A performed by a controller of the interference prevention control device.

FIG. 4 is a characteristic diagram showing characteristics of command signals output from the controller of the interference prevention control device to a solenoid-operated directional control valve.

FIG. 5 is a flow chart showing the details of interference prevention control B performed by the controller of the interference prevention control device.

### DETAILED DESCRIPTION OF THE INVENTION

Next, the present invention is explained in detail hereunder, referring to an embodiment thereof shown in the attached drawings.

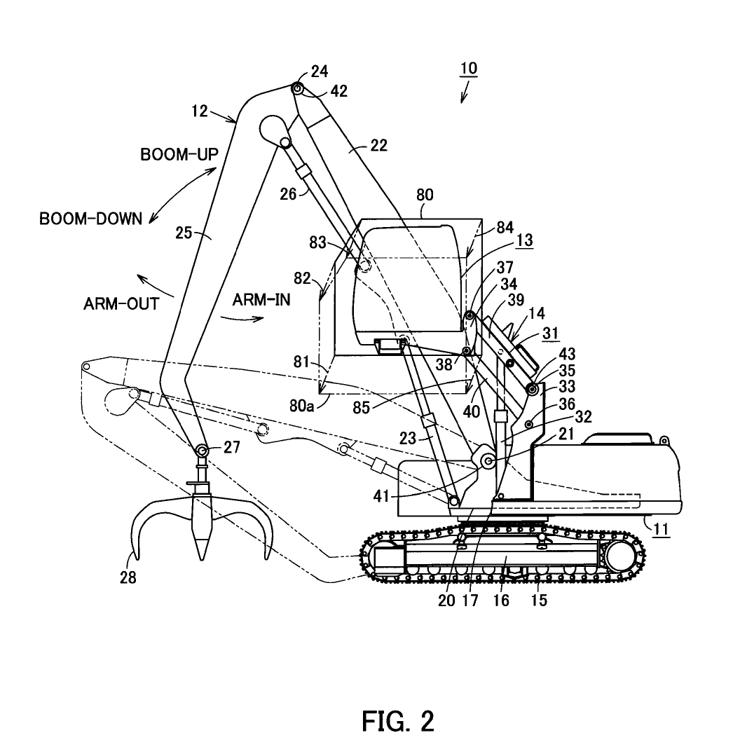

FIG. 2 illustrates a work machine 10. A front work equipment 12 serving as a work equipment is mounted on the machine body 11 of the work machine 10. At a side of the front work equipment 12, a cab 13 is mounted on the machine body 11 so as to be capable of being lifted above and lowered towards the machine body 11. A cab moving device 14 for lifting and lowering the cab 13 is provided between the cab 13 and the machine body 11. The machine body 11 includes a lower structure 16 equipped with crawler belts 15, and an upper structure 17 rotatably mounted on the lower structure 16.

The front work equipment 12, which is mounted on the machine body 11 together with the cab 13, includes a boom 22, the base end of which is pivotally supported at a swiveling frame 20 of the machine body 11 by a shaft and a boom foot pin 21. A boom cylinder 23 is provided between the swiveling frame 20 and the boom 22 and serves as an actuator for vertically pivoting the boom 22. The base end of an arm 25 is pivotally supported at the distal end of the boom 22 by a shaft and a boom end pin 24. An arm cylinder 26 is provided between the boom 22 and the arm 25 and serves as an actuator for pivoting the arm 25. A tool 28 is supported at the distal end of the arm 25 by a shaft and an arm end pin 27.

The tool 28 shown in the drawing is a grapple, which is used for demolition or other similar operations. As the grapple is driven to be opened or closed by a tool actuator (not shown) so as to grasp or release a workpiece, the diameter of the grapple changes. Other examples of the tool include a clamshell bucket, a magnet, a fork, and the like.

The cab moving device 14 includes a link mechanism 31 and a cab lifting cylinder 32. The link mechanism 31 serves to maintain the cab 13 at a prescribed attitude.

The cab lifting cylinder 32 serves as an actuator for lifting and lowering the cab 13.

The link mechanism 31 includes a support tower body 33, an L-shaped link connecting portion 34, an upper link 39, and a lower link 40. The support tower body 33 is provided, in an upright position, on the upper structure 17 of the machine body 11. The link connecting portion 34 is formed at the lower part of the cab 13 as an integral body with the cab 13. The upper link 39 and the lower link 40 are disposed between and pivotally connected to the upper part of the support tower body 33 and the back end of the link connecting portion 34 by means of pins 35,36,37,38 so that the upper link 39 and the lower link 40 are constantly maintained parallel to each other. The upper link 39 and the lower link 40 are adapted to be vertically pivoted by the cab lifting cylinder 32.

The base end of the cab lifting cylinder 32 is pivotally supported at the lower part of the support tower body 33 by a shaft and a pin. The cab lifting cylinder 32 has a piston rod, the distal end of which is pivotally connected to the upper link 39 by a pin.

As described above, the cab 13 can be lifted or lowered by the cab moving device 14. The front work equipment 12 includes the boom 22, which is attached to the machine body 11 so as to be capable of pivoting around the boom foot pin 21 by the boom cylinder 23; the arm 25, which is attached to the boom 22 so as to be capable of pivoting around the boom end pin 24 by the arm cylinder 26; and tool 28, which is attached to the arm 25 so as to be capable of pivoting around the arm end pin 27.

A boom angle sensor 41 for detecting an angle of the boom 22 with respect to the swiveling frame 20 is attached to an end of the boom foot pin 21, and an arm angle sensor 42 for detecting an angle of the arm 25 with respect to the boom 22 is attached to an end of the boom end pin 24. The boom angle sensor 41 and the arm angle sensor 42 together serve as a tool position sensor for detecting a position of the tool 28 attached to the distal end of the front work equipment 12. A cab position sensor 43 for detecting a position of the cab 13 by detecting an angle of the upper link 39 with respect to the support tower body 33 is attached to an end of the pin 35. Examples of devices that can be used as the boom angle sensor 41, the arm angle sensor 42, or the cab position sensor 43 include a rotary potentiometer.

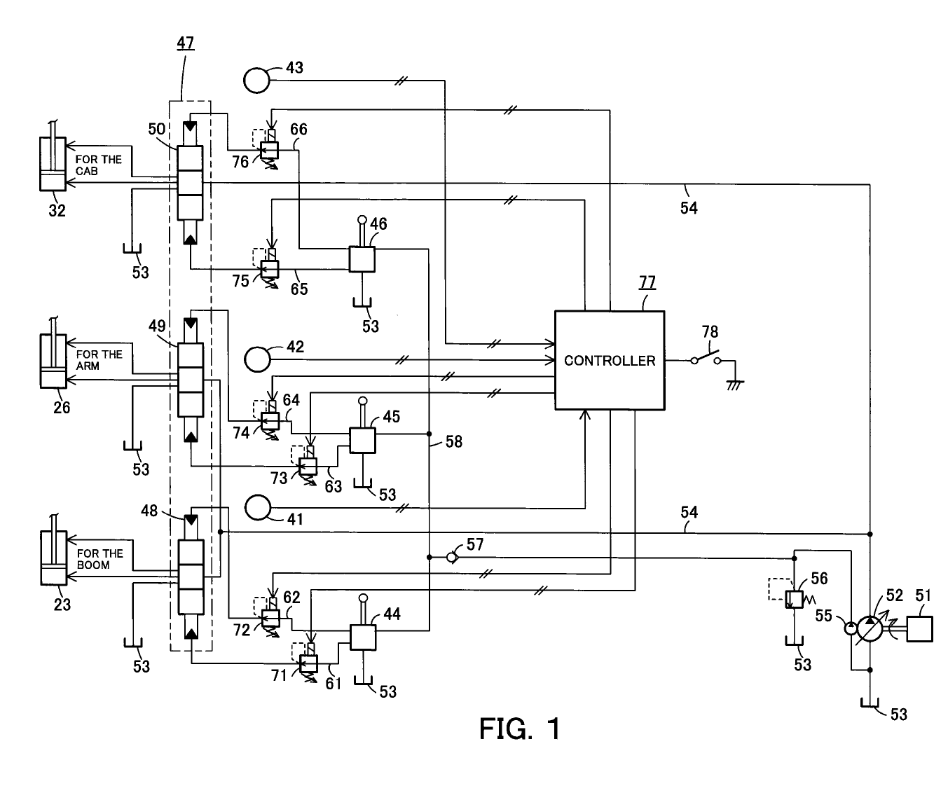

FIG. 1 illustrates a control circuit for controlling the cylinders. An operation unit provided with operation valves 44,45,46 is installed in the cab 13 and adapted to be operated by an operator seated in the seat. The machine body 11 is provided with travel motors (not shown in the drawings) mounted on the lower structure 16, a swivel motor (not shown) for swiveling the upper structure 17 on the lower structure 16, and a pilot-operated control valve 47 for controlling hydraulic actuators, such as the boom cylinder 23, the arm cylinder 26, and the cab lifting cylinder 32.

The pilot-operated control valve 47 includes, at least, spools 48,49,50 for controlling the boom cylinder 23, the arm cylinder 26, and the cab lifting cylinder 32, respectively.

The spools 48,49,50 have a function of controlling the direction and flow rate of hydraulic oil fed respectively to the boom cylinder 23, the arm cylinder 26, and the cab lifting cylinder 32 and returning the return oil into a tank 53. To be more specific, when a motor 51, which may be an on-vehicle engine, drives a main pump 52 so that the hydraulic oil is fed from the tank 53 to the spools 48,49,50 through a main passage 54, each spool 48,49,50 controls, based on its stroke position, the direction and flow rate of the hydraulic oil fed therefrom to the corresponding actuator, i.e. the boom cylinder 23, the arm cylinder 26, or the cab lifting cylinder 32, and returns the return oil into the tank 53.

A pilot pump 55 is provided and driven together with the main pump 52 by the motor 51. The pilot pump 55 serves to feed pressurized pilot oil at a pilot primary pressure, which is set at a relief valve 56, to the operation valves 44,45,46 through a primary pressure passage 58 provided with a check valve 57. The operation valves 44,45,46 feed pilot secondary pressures to pilot operation units of the respective spools 48,49,50 through secondary pressure passages 61,62,63,64,65,66, which serve as pilot passages. The amounts of pilot secondary pressures respectively correspond to the degrees of operation of the levers.

Solenoid-operated directional control valves 71,72 serving as a limiting means are disposed in the secondary pressure passages 61,62 to the boom. Solenoid-operated directional control valves 73,74 serving as a limiting means are disposed in the secondary pressure passages 63,64 to the arm. Solenoid-operated directional control valves 75,76 serving as a limiting means are disposed in the secondary pressure passages 65,66 to the cab.

These solenoid-operated directional control valves 71-76 are provided with solenoids, which are connected to an output section of a controller 77. The aforementioned boom angle sensor 41, arm angle sensor 42, and cab position sensor 43, as well as a switch 78 for initiating interference prevention control, are connected to an input section of the controller 77.

Based on the position of the cab 13 detected by the cab position sensor 43 (the position of the cab 13 hereinafter means the position of a cab interference area 80 set around the cab 13) and the moving speed of the cab 13 computed by differentiating the position of the cab 13, the controller 77 computes moving vectors 81,82,83,84,85 indicating movement of the cab interference area 80 to a predicted cab position 80a, which is the position the cab 13 should be after a prescribed time as illustrated in FIG. 2. Then, based on the moving vectors 81,82,83,84,85 of the cab interference area 80, the controller 77 predicts the cab position where the cab should be after the prescribed time, and controls the movement of the actuators of the front work equipment 12 through the solenoid-operated directional control valves 71,72,73,74 in order to prevent interference of the predicted cab position with the tool position.

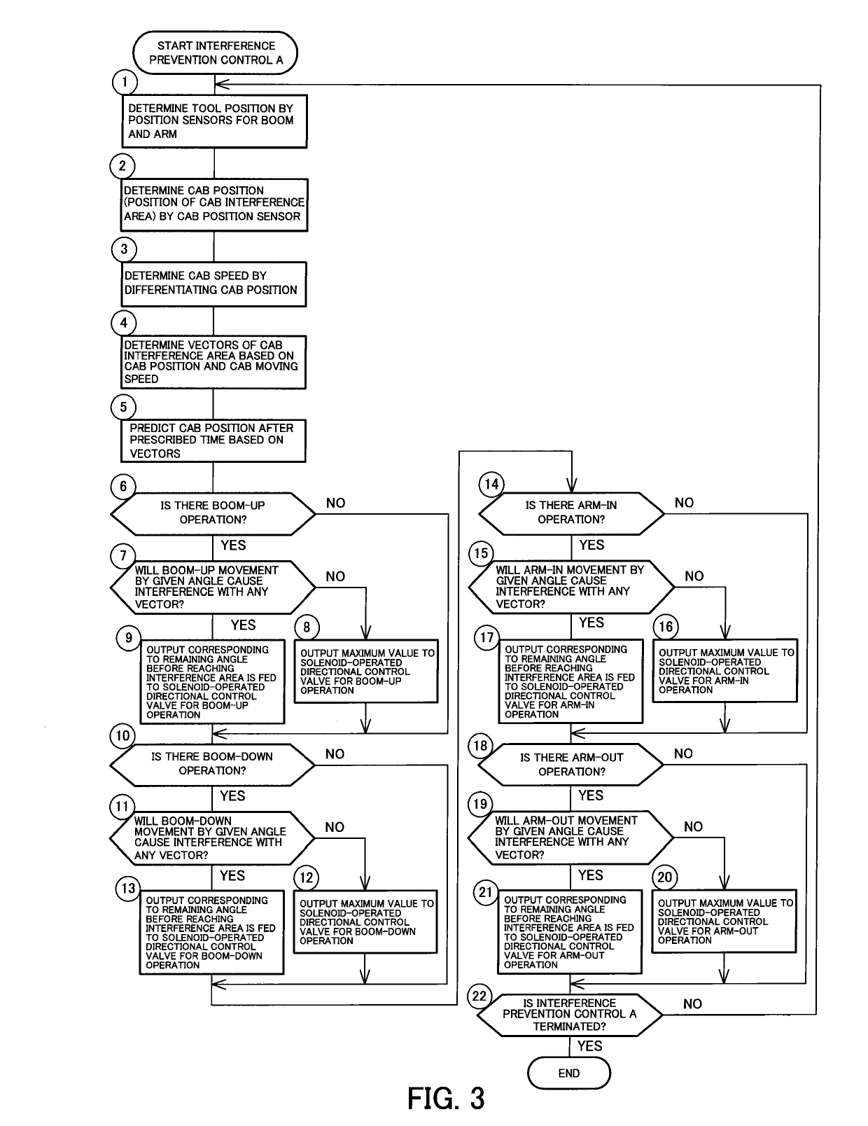

Next, interference prevention control A performed by the controller 77 is explained hereunder, referring to the flow chart illustrated in FIG. 3, wherein numerals enclosed with circles represent step numbers showing control procedures.

### (Step 1)

The coordinates of the distal end of the arm, i.e. the position of the tool 28, are determined by detecting the boom angle and the arm angle by means of the boom angle sensor 41 and the arm angle sensor 42, and multiplying the boom angle and the arm angle by the boom length and the arm length, which are already known.

### (Step 2)

The cab position, in other words the position of the cab interference area 80, is determined by detecting the angle of the link mechanism 31 by means of the cab position sensor 43. At that time, as the cab 13 is moved up or down in a horizontal attitude by means of the link mechanism 31, changes of the positions of various points of the cab interference area 80 can be grasped by specifying coordinates of a single point, for example the pin 37, of the cab 13 and tracking changes of the coordinates of the single point.

### (Step 3)

The moving speed of the cab 13 is computed by differentiating the cab position, which is a time function, with respect to time.

### (Step 4)

The moving vectors 81,82,83,84,85 of the cab interference area 80 are determined based on the position and moving speed of the cab.

### (Step 5)

The predicted cab position 80a, where the cab should be after a prescribed time, is predicted based on the moving vectors 81,82,83,84,85.

### (Step 6)

Whether or not there is a boom-up command is determined. If there is no boom-up command, the process proceeds to Step 10.

### (Step 7)

If a boom-up command is ascertained, whether or not a given amount of boom-up movement, in other words raising the boom by a given angle, will cause interference of the tool 28 with any one of the moving vectors 81,82,83,84,85 is determined.

### (Step 8)

If it is ascertained that the boom-up movement by the given angle will not cause the tool 28 to interfere with any one of the moving vectors 81,82,83,84,85, a signal commanding maximum operation is output to the solenoid-operated directional control valve 72 for boom-up operation so that the solenoid-operated directional control valve 72 is controlled to be in a fully open state. As a result, it is ensured that the boom can be raised at a speed corresponding to the degree of operation of the operation valve 44, because the boom-up pilot secondary pressure from the operation valve 44 is not limited.

### (Step 9)

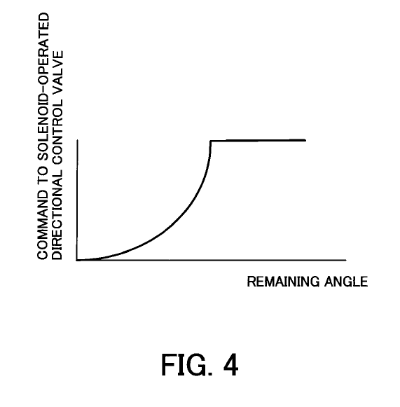

If it is ascertained that the boom-up movement by the given angle will cause the tool 28 to interfere with any one of the moving vectors 81,82,83,84,85, a command signal corresponding to the remaining angle of the tool 28, which continuously changes until the prescribed time has elapsed and the cab 13 reaches the predicted cab position, i.e. the predicted cab position 80a of the cab interference area 80, is output to the solenoid-operated directional control valve 72 for boom-up operation. As a result, even if the boom-up pilot secondary pressure has been generated in the amount corresponding to the degree of operation of the operation valve 44, the commanding signal output from the controller 77 to the solenoid-operated directional control valve 72 is gradually reduced in proportion to the decrease in the remaining angle as illustrated in FIG. 4 so that the boom-up pilot secondary pressure is gradually reduced, ultimately to zero, by means of the solenoid-operated directional control valve 72, regardless of the degree of operation of the operation valve 44.

### (Step 10)

Next, whether or not there is a boom-down command is determined. If there is no boom-down command, the process proceeds to Step 14.

### (Step 11)

If a boom-down command is ascertained, whether or not boom-down movement by a given angle will cause interference of the tool 28 with any one of the moving vectors 81,82,83,84,85 is determined.

### (Step 12)

If it is ascertained that the boom-down movement by the given angle will not cause the tool 28 to interfere with any one of the moving vectors 81,82,83,84,85, a signal commanding maximum operation is output to the solenoid-operated directional control valve 71 for boom-down operation so that the solenoid-operated directional control valve 71 is controlled to be in a fully open state. As a result, it is ensured that the boom can be lowered at a speed corresponding to the degree of operation of the operation valve 44, because the boom-down pilot secondary pressure from the operation valve 44 is not limited.

### (Step 13)

If it is ascertained that the boom-down movement by the given angle will cause the tool 28 to interfere with any one of the moving vectors 81,82,83,84,85, a command signal corresponding to the remaining angle of the tool 28, which continuously changes until the prescribed time has elapsed and the cab 13 reaches the predicted cab position, i.e. the predicted cab position 80a of the cab interference area 80, is output to the solenoid-operated directional control valve 71 for boom-down operation. As a result, even if the boom-down pilot secondary pressure has been generated in the amount corresponding to the degree of operation of the operation valve 44, the commanding signal output from the controller 77 to the solenoid-operated directional control valve 71 is gradually reduced in proportion to the decrease in the remaining angle as illustrated in FIG. 4 so that the boom-down pilot secondary pressure is gradually reduced, ultimately to zero, by means of the solenoid-operated directional control valve 71, regardless of the degree of operation of the operation valve 44.

### (Step 14)

Next, whether or not there is an arm-in command is determined. If there is no arm-in command, the process proceeds to Step 18.

### (Step 15)

If an arm-in command is ascertained, whether or not a given amount of arm-in movement, in other words moving the arm inward by a given angle, will cause interference of the tool 28 with any one of the moving vectors 81,82,83,84,85 is determined.

### (Step 16)

If it is ascertained that the arm-in movement by the given angle will not cause the tool 28 to interfere with any one of the moving vectors 81,82,83,84,85, a signal commanding maximum operation is output to the solenoid- operated directional control valve 74 for arm-in operation so that the solenoid-operated directional control valve 74 is controlled to be in a fully open state. As a result, it is ensured that the arm-in operation can be performed at a speed corresponding to the degree of operation of the operation valve 45, because the arm-in pilot secondary pressure from the operation valve 45 is not limited.

### (Step 17)

If it is ascertained that the arm-in movement by the given angle will cause the tool 28 to interfere with any one of the moving vectors 81,82,83,84,85, a command signal corresponding to the remaining angle of the tool 28, which continuously changes until the prescribed time has elapsed and the cab 13 reaches the predicted cab position, i.e. the predicted cab position 80a of the cab interference area 80, is output to the solenoid-operated directional control valve 74 for arm-in operation. As a result, even if the arm-in pilot secondary pressure has been generated in the amount corresponding to the degree of operation of the operation valve 45, the commanding signal output from the controller 77 to the solenoid-operated directional control valve 74 is gradually reduced in proportion to the decrease in the remaining angle as illustrated in FIG. 4 so that the arm-in pilot secondary pressure is gradually reduced, ultimately to zero, by means of the solenoid-operated directional control valve 74, regardless of the degree of operation of the operation valve 45.

(Step 18) Next, whether or not there is an arm-out command is determined. If there is no arm-out command, the process proceeds to Step 22.
(Step 19) If an arm-out command is ascertained, whether or not an arm-out movement by a given angle will cause interference of the tool 28 with any one of the moving vectors 81,82,83,84,85 is determined.

### (Step 20)

If it is ascertained that the arm-out movement by the given angle will not cause the tool 28 to interfere with any one of the moving vectors 81,82,83,84,85, a signal commanding maximum operation is output to the solenoid- operated directional control valve 73 for arm-out operation so that the solenoid-operated directional control valve 73 is controlled to be in a fully open state. As a result, it is ensured that the arm-out operation can be performed at a speed corresponding to the degree of operation of the operation valve 45, because the arm-out pilot secondary pressure from the operation valve 45 is not limited.

### (Step 21)

If it is ascertained that the arm-out movement by the given angle will cause the tool 28 to interfere with any one of the moving vectors 81,82,83,84,85, a command signal corresponding to the remaining angle of the tool 28, which continuously changes until the prescribed time has elapsed and the cab 13 reaches the predicted cab position, i.e. the predicted cab position 80a of the cab interference area 80, is output to the solenoid-operated directional control valve 73 for arm-out operation. As a result, even if the arm-out pilot secondary pressure has been generated in the amount corresponding to the degree of operation of the operation valve 45, the commanding signal output from the controller 77 to the solenoid-operated directional control valve 73 is gradually reduced in proportion to the decrease in the remaining angle as illustrated in FIG. 4 so that the arm-out pilot secondary pressure is gradually reduced, ultimately to zero, by means of the solenoid-operated directional control valve 73, regardless of the degree of operation of the operation valve 45.

### (Step 22)

Whether or not the interference prevention control has been terminated is determined by ascertaining whether the switch 78 is on or off. Throughout the period when interference prevention control continues, the process keeps returning to Step 1.

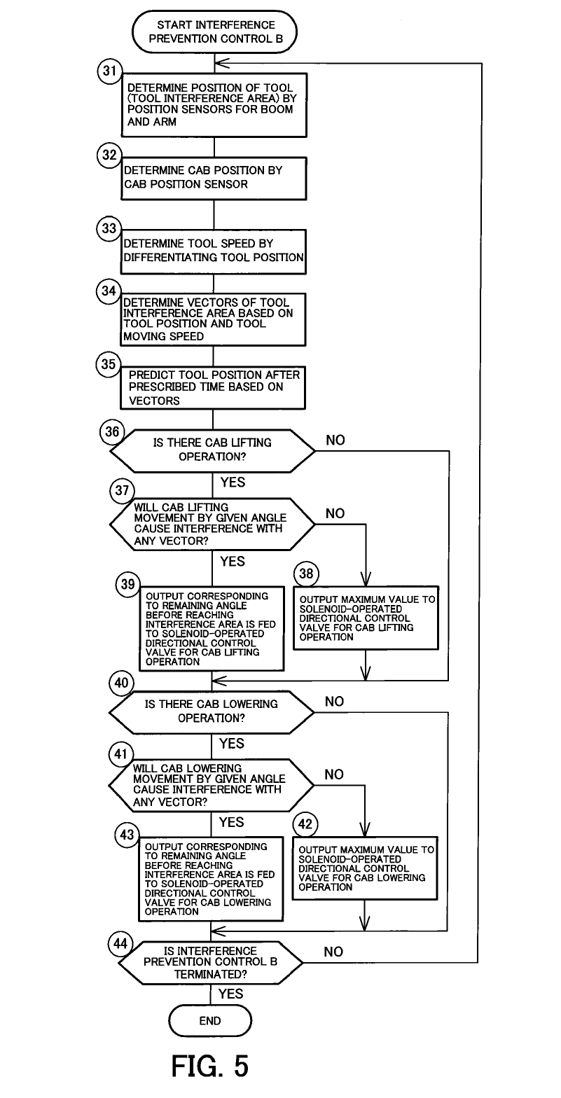

Next, interference prevention control B performed by the controller 77 is explained hereunder, referring to the flow chart illustrated in FIG. 5. In contrast to the interference prevention control A, the interference prevention control B serves to predict movement of the tool 28 based on the moving vectors and control the movement of the cab 13. The hardware for this control is the same as that illustrated in FIGS. 1, 2, and 4. However, instead of the moving vectors 81,82,83,84,85 of the cab interference area 80 illustrated in FIG. 2, the moving vectors of a tool interference area (not shown) that is set around the tool in the same manner as in the case of the interference prevention control A are determined and used.

Based on the position of the tool 28 detected by the boom angle sensor 41 and the arm angle sensor 42, as well as a moving speed of the tool 28 computed by differentiating the position of the tool 28, the controller 77 computes moving vectors (not shown) of the tool 28.

Then, based on the moving vectors of the tool 28, the controller 77 predicts the position where the tool 28 should be after a prescribed time, and controls the movement of the actuator of the cab 13, in other words the cab lifting cylinder 32, through the solenoid-operated directional control valves 75,76 in order to prevent interference of the predicted position of the tool 28 with the position of the cab 13.

### (Step 31)

The coordinates of the distal end of the arm, i.e. the position of the tool 28 (and by extension the position of the tool interference area), are determined by detecting the boom angle and the arm angle by means of the boom angle sensor 41 and the arm angle sensor 42, and multiplying the boom angle and the arm angle respectively by the boom length and the arm length, which are already known.

(Step 32) The cab position is determined by detecting the angle of the link mechanism 31 by means of the cab position sensor 43.

### (Step 33)

The moving speed of the tool 28 is computed by differentiating the tool position, which is a time function, with respect to time.

### (Step 34)

The moving vectors of the tool interference area are determined based on the position and moving speed of the tool.

### (Step 35)

The tool position where the tool should be after a prescribed time is predicted based on the moving vectors of the tool interference area.

### (Step 36)

Whether or not there is a cab lifting command is determined. If there is no cab lifting command, the process proceeds to Step 40.

### (Step 37)

If a cab lifting command is ascertained, whether or not a given amount of cab lifting movement, in other words moving the cab upward by a given angle, will cause interference of the cab 13 with any one of the moving vectors of the tool interference area is determined.

(Step 38) If it is ascertained that the cab lifting movement by the given angle will not cause the cab 13 to interfere with any one of the moving vectors of the tool interference area, a signal commanding maximum operation is output to the solenoid-operated directional control valve 76 for cab lifting operation so that the solenoid-operated directional control valve 76 is controlled to be in a fully open state. As a result, it is ensured that the cab can be lifted at a speed corresponding to the degree of operation of the operation valve 46, because the cab lifting pilot secondary pressure from the operation valve 46 is not limited.

### (Step 39)

If it is ascertained that the cab lifting movement by the given angle will cause the cab 13 to interfere with any one of the moving vectors of the tool interference area, a command signal corresponding to the remaining angle of the cab 13, which continuously changes until the prescribed time has elapsed and the tool 28 reaches the predicted tool position, i.e. the predicted position of the tool interference area, is output to the solenoid-operated directional control valve 76 for cab lifting operation. As a result, even if the cab lifting pilot secondary pressure has been generated in the amount corresponding to the degree of operation of the operation valve 46, the commanding signal output from the controller 77 to the solenoid-operated directional control valve 76 is gradually reduced in proportion to the decrease in the remaining angle as illustrated in FIG. 4 so that the cab lifting pilot secondary pressure is gradually reduced, ultimately to zero, by means of the solenoid-operated directional control valve 76, regardless of the degree of operation of the operation valve 46.

### (Step 40)

Whether or not there is a cab lowering command is determined. If there is no cab lowering command, the process proceeds to Step 44.

### (Step 41)

If a cab lowering command is ascertained, whether or not cab lowering movement by a given angle will cause interference of the cab 13 with any one of the moving vectors of the tool interference area is determined.

### (Step 42)

If it is ascertained that the cab lowering movement by the given angle will not cause the cab 13 to interfere with any one of the moving vectors of the tool interference area, a signal commanding maximum operation is output to the solenoid-operated directional control valve 75 for cab lowering operation so that the solenoid-operated directional control valve 75 is controlled to be in a fully open state. As a result, it is ensured that the cab can be lowered at a speed corresponding to the degree of operation of the operation valve 46, because the cab lowering pilot secondary pressure from the operation valve 46 is not limited.

### (Step 43)

If it is ascertained that the cab lowering movement by the given angle will cause the cab 13 to interfere with any one of the moving vectors of the tool interference area, a command signal corresponding to the remaining angle of the cab 13, which continuously changes until the prescribed time has elapsed and the tool 28 reaches the predicted tool position, i.e. the predicted position of the tool interference area, is output to the solenoid-operated directional control valve 75 for cab lowering operation. As a result, even if the cab lowering pilot secondary pressure has been generated in the amount corresponding to the degree of operation of the operation valve 46, the commanding signal output from the controller 77 to the solenoid-operated directional control valve 75 is gradually reduced in proportion to the decrease in the remaining angle as illustrated in FIG. 4 so that the cab lowering pilot secondary pressure is gradually reduced, ultimately to zero, by means of the solenoid-operated directional control valve 75, regardless of the degree of operation of the operation valve 46.

### (Step 44)

Whether or not the interference prevention control has been terminated is determined by ascertaining whether the switch 78 is on or off. Throughout the period when interference prevention control continues, the process keeps returning to Step 31.

As described above, the example of a control method illustrated in FIG. 3 is a control method by which the controller 77 computes the moving vectors of the cab based on the cab position and the moving speed of the cab determined by differentiating the detected cab position; based on the moving vectors, predicts the cab position where the cab should be after a prescribed time; and prevents interference of the tool 28 at the predicted cab position. On the other hand, according to the example of a control method illustrated in FIG. 5, the controller 77 computes the moving vectors of the tool based on the tool position and the moving speed of the tool determined by differentiating the detected tool position; based on the moving vectors, predicts the tool position where the tool should be after a prescribed time; and prevents interference of the cab 13 at the predicted tool position.

Either control method may be selected by the operator in the cab by inputting the selection from an input means, such as a monitor connected to the controller 77.

Next, functions and effects of the embodiment described above are explained.

According to the interference prevention control illustrated in FIGS. 1 to 3, the position of the cab 13 or the cab interference area 80 is detected by the cab position sensor 43. Then, the controller 77 computes the moving speed of the cab 13 or the cab interference area 80 by differentiating the detected position of the cab 13 or the cab interference area 80; determines the moving vectors 81,82,83,84,85 of the cab 13 or the cab interference area 80 based on the abovementioned position and moving speed of the cab 13 or the cab interference area 80; based on the moving vectors 81,82,83,84,85 of the cab 13 or the cab interference area 80, computes the predicted cab position 80a, which is the position the cab 13 should be after the prescribed time; and, if the tool position is predicted to interfere with the predicted cab position 80a, controls the solenoid-operated directional control valves 71-74 so as to limit the movement of the boom cylinder 23 and the arm cylinder 26, which are actuators of the front work equipment 12, independently of operation by the operator. As a result, work efficiency can be improved, because interference between the tool 28 of the front work equipment 12 and the cab 13 or the cab interference area 80 can be prevented even if the front work equipment 12 is moved while the cab 13 or the cab interference area 80 is moving.

According to the interference prevention control illustrated in FIG. 5, the position of the tool 28 is detected by the boom angle sensor 41 and the arm angle sensor 42, which together serve as the tool position sensor.

Then, the controller 77 computes the moving speed of the tool 28 by differentiating the detected position of the tool 28; determines the moving vectors of the tool 28 based on the abovementioned position and moving speed of the tool 28; based on the moving vectors of the tool 28, predicts the tool position where the tool 28 should be after the prescribed time; and, if the cab position is predicted to interfere with the predicted tool position, controls the solenoid-operated directional control valves 75,76 so as to limit the movement of the cab lifting cylinder 32, which is an actuator of the cab 13, independently of operation by the operator. As a result, work efficiency can be improved, because interference between the tool 28 of the front work equipment 12 and the cab 13 can be prevented even if the cab 13 is moved during operation, in other while the front work equipment 12 is moving.

In the control circuit illustrated in FIG. 1, the control means is composed of the solenoid-operated directional control valves 71-76 disposed in the secondary pressure passages 61-66, which serve as pilot passages of the pilot-operated control valve 47 for controlling movement of the boom cylinder 23 and the arm cylinder 26, or the cab lifting cylinder 32, all of which are hydraulic actuators. Therefore, the control circuit is capable of controlling movement of the hydraulic actuators with a high degree of accuracy and thereby reliably preventing interference between the tool 28 of the front work equipment 12 and the cab 13.

As illustrated in FIG. 4, in cases where the controller 77 determines that no interference will occur between the tool 28 of the front work equipment 12 and the cab 13, even if the boom, the arm or the cab is moved by the given amount, i.e. by the given angle, in other words, in cases where the remaining angle is large, the controller 77 outputs a signal commanding maximum operation to the appropriate one from among the solenoid-operated directional control valves 71-76, thereby ensuring high-speed operation with high work efficiency. In cases where the controller 77 predicts interference, in other words in cases where the remaining angle is small, the controller 77 outputs a command signal corresponding to the positional relationship between the tool 28 and the cab 13 to the appropriate one from among the solenoid-operated directional control valves 71-76, thereby reducing the operation speed as the tool 28 and the cab 13 approach each other, leading to shock-free, smooth stoppage.

The present invention is applicable to a work machine equipped with a movable cab.

1. An interference prevention control device of a work machine provided with a cab and a work equipment mounted on the machine body in such a manner that the cab and the work equipment are capable of moving independently of each other, the interference prevention control device comprising:
a cab position sensor detecting a position of the cab;
a tool position sensor detecting a position of a tool attached to the work equipment;
a limiter movement of an actuator that serves to operate the work equipment; and
a controller that serves to:
determine a moving vector of the cab based on a cab position and a moving speed of a cab, the cab position being detected by the cab position sensor, and the moving speed of the cab being computed by differentiating the detected cab position;
based on the moving vector of the cab, predict the cab position where the cab should be after a prescribed time; and
control the movement of the actuator of the work equipment by means of the limiting means so as to prevent interference between the predicted cab position and the position of the tool.

2. An interference prevention control device of a work machine provided with a cab and a work equipment mounted on the machine body in such a manner that the cab and the work equipment are capable of moving independently of each other, the interference prevention control device comprising:
a cab position sensor detecting a position of the cab;
a tool position sensor detecting a position of a tool attached to the work equipment;
a limiter limiting movement of an actuator that serves to operate the cab; and
a controller that serves to:
determine a moving vector of the tool based on a tool position and a moving speed of a tool, the tool position being detected by the tool position sensor, and the moving speed of the tool being computed by differentiating the detected tool position;
based on the moving vector of the tool, predict the tool position where the tool should be after a prescribed time; and
control the movement of the actuator of the cab by means of the limiting means so as to prevent interference between the predicted tool position and the position of the cab.

3. An interference prevention control device of a work machine as claimed in claim 1, wherein:
the actuator that has had movement thereof limited by the limiter is a hydraulic actuator that has had movement thereof controlled by a pilot-operated control valve; and
the limiter is a solenoid-operated directional control valve disposed in a pilot passage of the pilot-operated control valve.

4. An interference prevention control device of a work machine as claimed in claim 3, wherein the controller is adapted to:
output a signal commanding maximum operation to the solenoid-operated directional control valve in cases where the controller determines, based on the predicted positional relationship after a prescribed time, that movement of the tool or the cab by a given amount will cause no interference between the tool and the cab; and
output a command signal corresponding to the positional relationship in cases where the controller predicts interference.
